(19) United States
(12) Patent Application Publication
(10) Pub. No.: US 2010/0134724 A1
(43) Pub. Date: Jun. 3, 2010

(54) Optical Element, Polarizing Plate, Retardation Plate, Illuminating Device and Liquid Crystal Display

(75) Inventors: Kohei Arakawa, Tokyo (JP); Toshihiko Hore, Tokyo (JP); Shuhei Okude, Tokyo (JP); Manabu Haraguchi, Tokyo (JP)

Correspondence Address: BIRCH STEWART KOLASCH & BIRCH, PO BOX 747, FALLS CHURCH, VA, 22040-0747, US

(73) Assignee: ZEON CORPORATION, Tokyo (JP)

(21) Appl. No.: 11/990,143

(22) PCT Filed: Aug. 10, 2006
(86) PCT No.: PCT/JP2006/315798

§ 371 Date: May 6, 2008

(30) Foreign Application Priority Data
Aug. 10, 2005 (JP) 2005-231933
Aug. 10, 2005 (JP) 2005-231934

(51) Int. Cl. G02F 1/1335; G02B 5/00; C09K 19/02; G02B 27/28; F21V 13/12; F21V 9/14

(52) U.S. Cl. 349/96; 359/896; 349/176; 359/485; 362/307; 362/19

(57) ABSTRACT

A polymerizable liquid crystal compound, a polymerization initiator, and a chiral agent, and a surfactant, orientation adjuster or the like as necessary are dissolved in a solvent to obtain a embrocation, the embrocation is laminated on an isotropic transparent film in a film state and dried, and the dried film is polymerized to give an optical element in which a lower limit λ_{L} of a band reflecting light at an incident angle of 0 degrees is longer than a wavelength λ_{R1} of light indicating the maximum emission intensity in a wavelength band of 600 nm to 700 nm in the light emitted by a light source, and an average transmittance of the light with the wavelength 600 nm to 700 nm at the incident angle of 60 degrees is 40% or more and 90% or less.

### TECHNICAL FIELD

The present invention relates to an optical element, a polarizing plate, a retardation plate, an illuminating device and a liquid crystal display. More specifically, the present invention relates to an optical element, a polarizing plate, a retardation plate, an illuminating device and a liquid crystal display used for displaying an image with well-balanced colors in observations similarly from the front and obliquely.

### BACKGROUND ART

A liquid crystal display comprises a light source, two dichroic polarizers and a liquid crystal cell arranged between the dichroic polarizers. Light from a light source such as a cold cathode tube, a hot cathode tube and an LED (light emitting diode), and EL (electroluminescence) has blue light (wavelength 410 nm to 470 nm), green light (wavelength 520 nm to 580 nm) and red light (wavelength 600 nm to 660 nm) balanced to emit white light. The light is converted by the first dichroic polarizer to linear polarized light. The linear polarized light is converted to linear polarized light with its phase unchanged or inverted depending on whether a voltage is applied or not in the liquid crystal cell. If a polarization transmission axis of the first dichroic polarizer and the polarization transmission axis of the second dichroic polarizer (also called as analyzer) are at a right angle, the linear polarized light whose phase is inverted in the liquid crystal cell transmits the second dichroic polarizer, while the linear polarized light with the phase unchanged can not transmit the second dichroic polarizer. In general, even with the one that can invert a phase of light incident from an incident angle of 0 degrees (that is, the phase is retarded by a half wavelength), the phase of the light incident obliquely can not be retarded to exactly a half wavelength, which causes distortion. The degree of distortion is different depending on wavelength. As a result, color of a color image observed from the front becomes different from the color of the color image observed obliquely.

A reflective polarizer might be used in order to improve brightness. In the reflective polarizer, a selective reflection band of light incident from a angle is shifted to the short wavelength side as compared with the selective reflection band of the light incident from the front. Even with the reflective polarizer that can reflect the entire visible region for the light incident from the front, the light incident obliquely can not be reflected in some cases for the long-wavelength light (red light). Under these circumstances, the color of a color image when observed from the front is different in general from the color of the color image when observed obliquely in a liquid crystal display.

In order to solve the difference in color by observing angle, Patent Document 1 proposes that a collimator consisting of a cholesteric liquid crystal layer showing a selective reflection band in a wavelength of λ₁ to λ₂ (λ₁<λ₂) for a perpendicular incident light and satisfying λ₀<λ₁ for the maximal wavelength λ₀ of a light emitting spectrum of a light source used in combination is arranged in a backlight system. The collimator described in Patent Document 1 has a function to align light traveling at various angles only to light traveling in the perpendicular direction. Therefore, the light incident from an angle is reflected by the collimator and not transmitted.

Patent Document 2 proposes that an infrared reflective layer (B) having a transmission characteristic for incident light in a visible region in a normal direction and having a reflective wavelength band in an infrared region, in which the reflective wavelength band is shifted to the short wavelength side as the incident angle to the normal direction becomes larger, is arranged in an illuminating device. Patent Document 2 discloses the infrared reflective layer (B) having transmittance of light with the wavelength 710 nm, 640 nm or 610 nm at an incident angle of 45 degrees at 10% or less. Therefore, the red light incident from an angle is substantially fully reflected or absorbed by the infrared reflective layer (B).

Patent Document 1: Japanese Patent Laid-Open No. 2002-169026 (U.S. Publication No. 2002/0036735)

Patent Document 2: Japanese Patent Laid-Open No. 2004-309618

### DISCLOSURE OF THE INVENTION

### Problems to be Solved by the Invention

The objective of the present invention is to provide an optical element, a polarizing plate, a retardation plate, an illuminating device and a liquid crystal display used for displaying an image with well-balanced colors in observations similarly from front and an angle. Specifically, the objective of the present invention is to provide an optical element, a polarizing plate, a retardation plate, an illuminating device and a liquid crystal display whose characteristics such as transmittance is appropriately changed according to an incident angle.

### Means for Solving the Problems

The inventors have found that when a liquid crystal display disclosed in the above Patent Documents is observed from the front, an image in which blue, green and red are well-balanced can be obtained, but when observed from an angle, the image becomes bluish on black display. And the inventors have found that the cause is that the collimator or the infrared reflective layer (B) used in Patent Document 1 and 2 shields too much red light incident from an angle.

Then, the inventors have found that by providing an optical element having a band reflecting light at an incident angle of 0 degrees in a band (λ_{L} to λ_{H}) of a wavelength longer than wavelength λ_{R1} of light indicating the maximum emission intensity in the wavelength region of 600 nm to 700 nm of the light source and average transmittance of the light with the wavelength of 600 nm to 700 nm at the incident angle of 60 degrees at 40% or more and 80% or less in an illuminating device of a liquid crystal display, an image with well-balanced color similarly in front and diagonal observation can be displayed.

Also, the inventors have found that by providing an optical element having a resin layer with cholesteric regularity, chiral pitch of the resin layer at 400 nm or more and the maximum reflectivity in the selective reflection band at the incident angle of 0 degrees at 10% or more and 40% or less in an illuminating device of a liquid crystal display, an image with well-balanced color similarly in the front and diagonal observations can be displayed. Based on the findings, the inventors have proceeded with the examination and completed the present invention.

The present invention includes the following:

(1) An optical element used in a device having a light source, in which

a lower limit λ_{L} of a wavelength band reflecting light at an incident angle of 0 degrees is longer than the wavelength λ_{R1} of the light indicating the maximum emission intensity in a wavelength band of 600 nm to 700 nm in the light emitted by the light source; and

average transmittance of the light with the wavelength 600 nm to 700 nm at the incident angle of 60 degrees is 40% or more and 80% or less.

(2) The optical element according to the above, wherein the average transmittance of the light with the wavelength 600 nm to 700 nm at the incident angle of 0 degrees is 60% or more and the average transmittance of the light with the wavelength of 600 nm to 700 nm at the incident angle of 0 degrees is larger than the average transmittance of the light with the wavelength of 600 nm to 700 nm at the incident angle of 60 degrees.
(3) The optical element according to the above, wherein the average transmittance of the light with the wavelength 600 nm to 700 nm at the incident angle of 60 degrees is 50% or more and 80% or less.
(4) The optical element according to the above, comprising a resin layer having cholesteric regularity.
(5) The optical element according to the above, which has a resin layer having cholesteric regularity, wherein chiral pitch of the resin layer is 400 nm or more; and the maximum reflectivity in a selective reflection band at the incident angle of 0 degrees is 10% or more and 40% or less.
(6) The optical element according to the above, wherein the reflectivity when light with the wavelength indicating the maximum reflectivity in the selective reflection band at the incident angle of 0 degrees is incident at the incident angle of 60 degrees is 50% or more and 90% or less of the maximum reflectivity at the incident angle of 0 degrees.
(7) The optical element according to the above, wherein the average reflectivity of light with the wavelength 600 nm to 700 nm at the incident angle of 60 degrees is 20% or more and 60% or less.
(8) An optical element having a resin layer with cholesteric regularity, wherein chiral pitch of the resin layer is 400 nm or more, and the maximum reflectivity in the selective reflection band at the incident angle of 0 degrees is 10% or more and 40% or less.
(9) The optical element according to the above, wherein the reflectivity when light with the wavelength indicating the maximum reflectivity in the selective reflection band at the incident angle of 0 degrees is incident at the incident angle of 60 degrees is 50% or more and 90% or less of the maximum reflectivity at the incident angle of 0 degrees.
(10) The optical element according to the above, wherein the average reflectivity of light with the wavelength 600 nm to 700 nm at the incident angle of 60 degrees is 20% or more and 60% or less.
(11) A polarizing plate in which the optical element according to the above and a linear polarizer are laminated.
(12) A retardation plate in which the optical element according to the above and retardation element are laminated.
(13) An illuminating device in which an optical reflective element, a light source, a light diffusing element and the optical element according to the above are arranged in this order.
(14) A polarization illuminating device in which an optical reflective element, a light source, a light diffusing element and the polarizing plate according to the above are arranged in this order.
(15) A liquid crystal display in which an optical reflective element, a light source, a light diffusing element, the optical element according to the above, a linear polarizer, a liquid crystal panel, and an analyzer are arranged in this order.
(16) The liquid crystal display according to the above, in which the light source is selected from a cold cathode tube, a hot cathode tube, a light emitting diode, and an electroluminescence.

### ADVANTAGES OF THE INVENTION

A conventional liquid crystal display is often reddish when observed from an angle. That is because a light amount of red when observed from an angle is relatively higher than the light amounts of blue and green as compared with light-amount balance of blue, green and red when observed from the front. On the other hand, if the transmittance of light with the wavelength 710 nm, 640 nm or 610 nm incident from an angle is 10% or less as in Patent Documents 1 and 2, the red light amount when observed from an angle is relatively much lower than the light amounts of blue and green as compared with the light-amount balance of blue, green and red when observed from the front. As a result, when the liquid crystal display is observed from an angle, it tends to become bluish, reddish or dark.

The optical element of the present invention transmits light with the wavelength of 600 nm to 700 nm incident at the incident angle of 60 degrees in a range of 40% or more and 80% or less, and if this is attached to a device having a light source, the color balance of blue, green and red when observed from an angle can be adjusted to the similar balance of blue, green and red when observed from the front. As a result, reddish or bluish display does not occur when observed from an angle, and color reproduction range can be widened.

The optical element of the present invention has a cholesteric resin layer with chiral pitch of 400 nm or more and the maximum reflectivity in the selective reflection band at the incident angle of 0 degrees being 10% or more and 40% or less. In the cholesteric resin layer, as the incident angle is increased, the selective reflection band is shifted to the short-wavelength side, and if the optical element of the present invention is attached to a device having a light source, the color balance of blue, green and red when observed from an angle can be adjusted to the balance similar to the balance of blue, green and red when observed from the front. As a result, reddish or bluish display does not occur when observed from an angle, and color reproduction range can be widened.

In this specification, the terms “x or more” and “y or less” include their boundary values x and y. The wording “less than x” and “exceeding y” do not include the boundary values x and y. The boundary values x and v in a range indicated by “x to y” are included in the range.

### BRIEF DESCRIPTION OF THE DRAWINGS

FIG. 1 is a diagram illustrating an example of a light emitting spectrum of a light source.

FIG. 2 is a diagram for explaining a selective reflection band.

FIG. 3 is a diagram illustrating an example of an optical element (circular polarizing reflector) of the present invention.

FIG. 4 is a diagram illustrating configuration of an example of a liquid crystal display of the present invention.

### EXPLANATION OF SYMBOLS

1: Transparent substrate
2: Oriented film
3: Cholesteric resin layer
11: Polarizer Y (analyzer)
12: Liquid crystal cell
13: Polarizer X
17: Optical element of the present invention (circular polarizing reflector)
18: Light diffusing plate
19: Cold cathode tube
20: Reflector

### BEST MODE FOR CARRYING OUT THE INVENTION

In an optical element of the present invention, a lower limit λ_{L} of a wavelength band reflecting light at an incident angle of 0 degrees is longer than the wavelength λ_{R1} of the light indicating the maximum emission intensity in the wavelength band of 600 nm to 700 nm in the light emitted by the light source, and average transmittance of the light with the wavelength 600 nm to 700 nm at the incident angle of 60 degrees is 40% or more and 80% or less. The optical element of the present invention is a member used with the light source and arranged on the light outgoing side of the light source and specifically, it may be a reflective polarizer or more specifically, a circular polarizing plate.

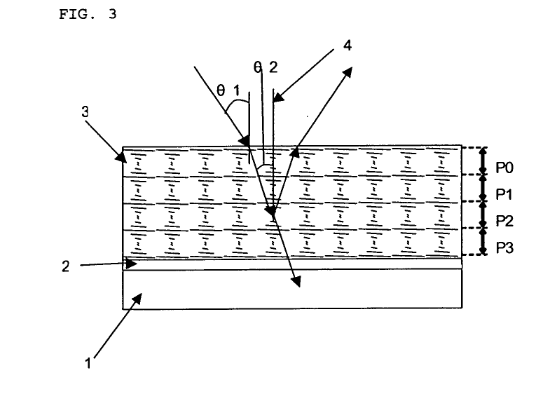

The optical element of the present invention has a wavelength band reflecting light (hereinafter, referred to as selective reflection band). A solid line in FIG. 2 indicates wavelength dependence of reflectivity at an incident angle of 0 degrees. The selective reflection band is a portion as shown by the solid line 30 with the reflectivity in a specific wavelength region (wavelength region from λ_{L} to λ_{H}) larger than the other regions. In FIG. 2, the reflectivity clearly changes at the boundary between the selective reflection band and a non-selective reflective band, and the graph forms a rectangular or trapezoidal shape, but the reflectivity may be gently changed and the graph may form a gentle angular shape such as a parabola. Here, the lower limit λ_{L} and the upper limit λ_{H} of the selective reflection band are the shortest and the longest in the wavelengths indicating the reflectivity of ½ times of the maximum reflectivity in the selective reflection band.

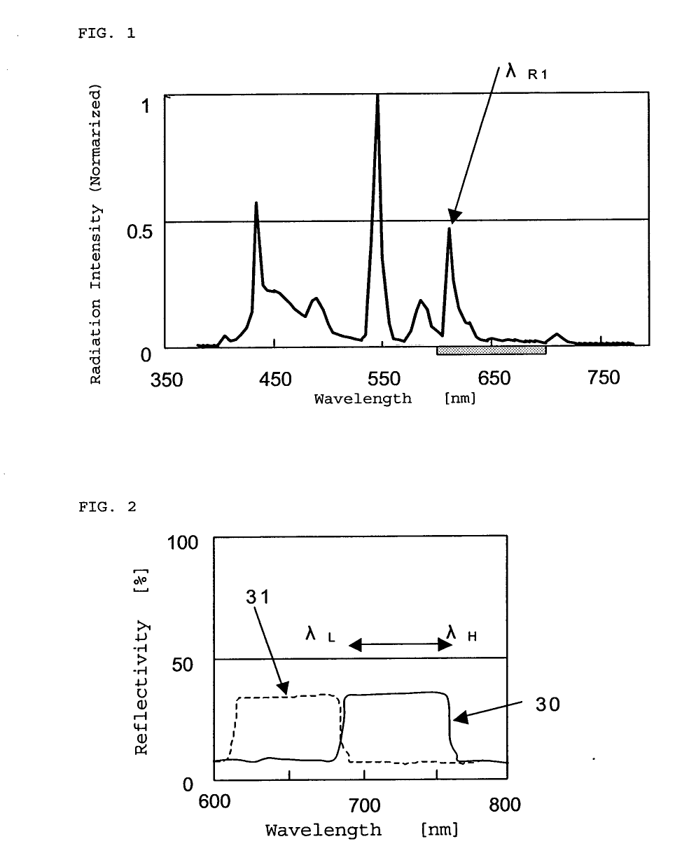

FIG. 1 is a diagram illustrating an example of a light-emitting spectrum of a light source (cold cathode tube) used in a liquid crystal display. λ_{R1} is the wavelength of light showing the maximum emission intensity in the wavelength band of 600 nm to 700 nm in the light emitted by the light source.

The band reflecting the light (selective reflection band) has its wavelength range changed according to an incident angle. In the present invention, the lower limit λ_{L} of the band reflecting the light at the incident angle 0 degrees is longer than the wavelength limit λ_{R1}.

Moreover, in the optical element of the present invention, λ_{L} is preferably longer than a wavelength λ_{R2} of the light indicating the maximum emission intensity in the wavelength band of 630 nm to 700 μm in the light emitted by the light source. If λ_{L} is longer as a wavelength, the color balance in the front observation can be well-balanced and a value of area ratio in a color reproduction range with respect to a chromaticity region can be improved.

In FIG. 1, since λ_{R1} is approximately 610 nm, λ_{L} is preferably a wavelength longer than 610 nm. λ_{L} in the selective reflection band shown by the solid line 30 in FIG. 2 is approximately 680 nm. A width of the selective reflection band (difference between λ_{H} and λ_{L}) is preferably 50 nm or more, particularly preferably 80 nm or more.

The maximum reflectivity in the selective reflection band at the incident angle 0 degrees is preferably 10% or more and 40% or less, more preferably 15% or more and 35% or less. If the maximum reflectivity is in the above range, when a display screen of a liquid crystal display is observed from an angle, an image with the color balance similar to that of the front observation can be obtained. If the maximum reflectivity is low, the image becomes reddish when observed from an angle. If the maximum reflectivity is high, the image becomes bluish when observed from an angle.

In the optical element of the present invention, a reflectivity when light with a wavelength indicating the maximum reflectivity in the selective reflection band at an incident angle of 0 degrees is incident at the incident angle of 60 degrees is preferably 50% or more and 90% or less, or more preferably 60% or more and 85% or less of the maximum reflectivity at the incident angle of 0 degrees.

In the optical element of the present invention, an average transmittance of light with the wavelength of 600 nm to 700 nm at the incident angle of 0 degrees is preferably 60% or more, or more preferably 70% or more. Moreover, the average transmittance of the light with the wavelength of 600 nm to 700 nm at the incident angle of degrees is preferably larger than the average transmittance of the light with the wavelength of 600 nm to 700 nm at the incident angle of 60 degrees. Specifically, the average transmittance of the light with the wavelength of 600 nm to 700 nm at the incident angle of 60 degrees is preferably 94% or less of the average transmittance of the light with the wavelength of 600 nm to 700 nm at the incident angle of 0 degrees.

The light transmittance at the incident angle of 0 degrees of blue light and green light can be selected as appropriate, considering light-amount balance with respect to red light. The average transmittances of the blue light (wavelength of 400 nm to 500 nm) and the green light (wavelength of 500 nm to 600 nm) at the incident angle of 0 degrees are preferably 60% or more, or more preferably 70% or more. In this specification, the average transmittance is an arithmetic average value of transmittance measured by a wavelength interval of 10 nm.

The selective reflection band is preferably shifted to the short wavelength side as the incident angle of the light becomes large. Specifically, the selective reflection band at the incident angle of 60 degrees preferably covers the wavelengths of λ_{R1} and λ_{R2}. As the incident angle becomes large, the selective reflection band is shifted to the short wavelength side. As a result, the average transmittance of light with the wavelength of 600 nm to 700 nm at the incident angle of 60 degrees can be lowered.

A broken line 31 in FIG. 2 shows an example of the selective reflection band at the incident angle of 60 degrees. In FIG. 2, the lower limit of the selective reflection band is approximately 610 nm.

The optical element of the present invention has the average transmittance of light with the wavelength 600 nm to 700 nm at the incident angle of 60 degrees at 40% or more and 80% or less, or more preferably 50% or more and 80% or less. If the light transmittance is less than the above range, the display image observed from an angle becomes bluish. If the light transmittance exceeds the above range, the display image observed from an angle becomes reddish.

In the optical element of the present invention, the average transmittances of the blue light (wavelength 400 nm to 500 nm) and the green light (wavelength 500 nm to 600 nm) at the incident angle of 60 degrees are preferably 60% or more, or more preferably 70% or more.

The average transmittance of light with the wavelength of 600 nm to 700 nm at the incident angle of degrees is preferably smaller than the average transmittances of the blue light (wavelength 400 nm to 500 nm) and the green light (wavelength 500 nm to 600 nm) at the incident angle of 60 degrees, or more specifically, it is preferably smaller than the average transmittances of the blue light (wavelength 400 nm to 500 nm) and the green light (wavelength 500 nm to 600 nm) at the incident angle of 60 degrees by 5% to 30%.

In the optical element of the present invention, the average reflectivity of light with the wavelength of 600 nm to 700 nm at the incident angle of 60 degrees is preferably 20% or more and 60% or less, or more preferably 25% or more and 50% or less.

The optical element of the present invention is not particularly limited by its structure as long as characteristics of transmittance or reflectivity is changed according to the incident angle as mentioned above. The optical element of the present invention includes a multi-layer thin film in which inorganic oxides with different refractive indexes are deposited alternately (cold filter, for example); a thin film in which resin films with different refractive indexes are laminated; an infrared reflective film obtained by biaxially drawing a multi-layer film of resins with different refractive indexes; an infrared reflective film obtained by uniaxially stretching two types of resin films with different refractive indexes and the film is crossed by each other and laminated; those with a selective reflection band of the circular polarizing reflector containing a resin layer having cholesteric regularity made as an infrared region; those obtained by laminating right-twisted and left-twisted circular polarizing reflectors; those obtained by laminating two pieces of the circular polarizing reflectors containing a resin layer having cholesteric regularity in the same twisting direction through a ½ wavelength plate; and a grid polarizer, for example.

The optical element of the present invention is an optical element having a resin layer with cholesteric regularity, chiral pitch of the resin layer at 400 nm or more, and the maximum reflectivity in the selective reflection band at the incident angle of 0 degrees being 10% or more and 40% or less.

The optical element of the present invention has a resin layer with cholesteric regularity (hereinafter, referred to as cholesteric resin layer). The cholesteric regularity is a structure that an angle of molecular axes are sequentially displaced (twisted) in the normal direction of a plane such that the molecular axes are aligned in a given direction on one plane but the direction of the molecular axes is slightly displaced with an angle on the subsequent plane and the angle is further displaced on the subsequent plane. Such a structure that the direction of the molecular axes is twisted is called as a chiral structure. The normal line of the plane (chiral axis) is preferably substantially in parallel with the thickness direction of the cholesteric resin layer. The thickness of the cholesteric resin layer is preferably 1 μm to 10 μm, or more preferably 1 μm to 5 μm.

The cholesteric resin layer used in the present invention has its chiral pitch at 400 nm or more, or preferably 430 nm or more. The chiral pitch is a distance in the chiral axial direction from when the angle begins to be displaced little by little as the direction of the molecular axis progresses on the plane in the chiral structure till it returns to the original molecular axial direction.

Among them, with the circular polarizing reflector comprising a resin layer with cholesteric regularity, adjustment of the selective reflection band is relatively easy. Thus, the circular polarizing reflector comprising a resin layer with cholesteric regularity will be described.

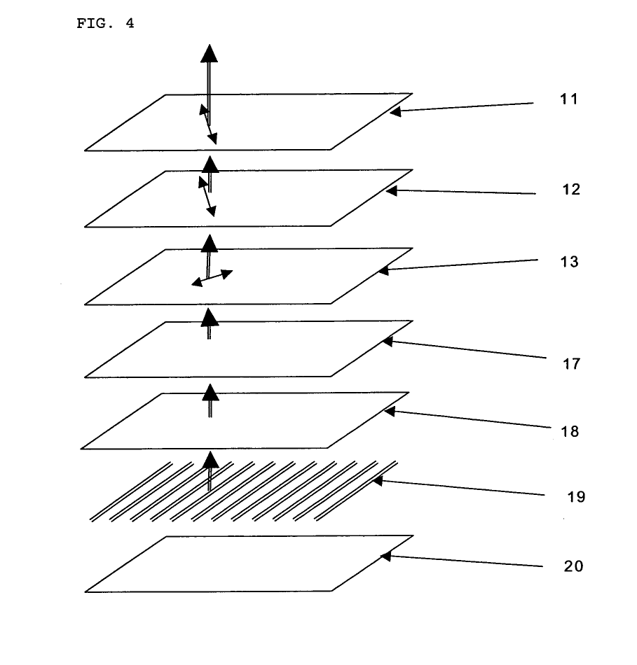

FIG. 3 is a diagram illustrating a structure of an example of the optical element (circular polarizing reflector) of the present invention.

This circular polarizing reflector can be obtained by forming an oriented film 2 on a sheet-like transparent substrate 1 and by further forming a resin layer 3 having cholesteric regularity thereon.

### [Transparent Substrate]

The transparent substrate is not particularly limited as long as it is an optically transparent base material, but in order to avoid change of the polarized light, those with small phase difference due to double refraction and optical isotropy are preferable. Such a transparent substrate includes a transparent resin film, a glass substrate and the like, and from a viewpoint of efficient manufacture, a lengthy transparent resin film is more preferable. The transparent resin film may be a single-layer film or multi-layer film but it preferably has full-light transmittance of 80% or more with the thickness of 1 mm.

Resin materials of the transparent resin film include alicyclic structure containing polymer resin, leaner-chain olefin polymer such as polyethylene and polypropylene; triacetylcellulose, polyvinyl alcohol, polyimide, polyarylate, polyester, polycarbonate, polysulfone, polyethersulfone, amorphous polyolefin, modified acrylic polymer, epoxy resin and the like. They can be used alone or in combination of two or more. Among them, the alicyclic structure containing polymer resin or linear-chain olefin polymer is preferable, and the alicyclic structure containing polymer resin is more preferable from the viewpoint of transparency, low hygroscopicity, dimensional stability, light weight and the like.

An alicyclic structure containing polymer resin includes (1) norbornene polymer; (2) single-ring cyclic olefin polymer; (3) cyclic conjugated diene polymer; (4) vinyl alicyclic hydrocarbon polymer and their hydrogenated products. Among them, the norbornene polymer is preferable from the viewpoint of transparency and moldability.

The norbornene polymer includes, for example, ring-opening polymer of norbornene monomers, ring-opening copolymer of norbornene monomers and other monomers capable of ring-opening copolymerization and their hydrogenated products; addition polymer of norbornene monomers, addition copolymer of norbornene monomers and other monomers capable of copolymerization and the like. Among them, hydrogenated products of ring-opening polymer with norbornene monomers is the most preferable from the viewpoint of transparency. A polymer having the above alicyclic structure is selected from known polymers disclosed in Japanese Patent Laid-Open No. 2002-321302, for example.

The resin material of the transparent resin film suitable for the present invention has its glass transition temperature preferably at 80° C. or more, or more preferably in a range of 100 to 250° C. The transparent resin film composed of the resin material with the glass transition temperature in this range does not cause deformation or stress in use under a high temperature and is excellent in durability.

The molecular weight of the resin material of the transparent resin film suitable to the present invention is, when being measured by gel permeation chromatography (hereinafter abbreviated as “GPC”) with cyclohexane (or toluene if the polymer resin is not dissolved) as solvent, the weight-average molecular weight (Mw) in polyisoprene (or polystyrene when solvent is toluene) conversion is usually in a range of 10,000 to 100,000, preferably 25,000 to 80,000, or more preferably 25,000 to 50,000. When the weight-average molecular weight is in this range, mechanical strength and moldability of the film are well balanced and suitable.

Molecular weight distribution of the resin material of the transparent resin film suitable to the present invention (weight-average molecular weight (Mw)/number-average molecular weight (Mn)) is not particularly limited but it is usually 1.0 to 10.0, preferably 1.0 to 4.0, or more preferably 1.2 to 3.5.

In the resin material of the transparent resin film suitable for the present invention, a content of a resin component with the molecular weight of 2,000 or less (that is, an oligomer component) is preferably 5% by weight or less, or more preferably 3% by weight or less, or further preferably 2% by weight or less. If the amount of the oligomer component is large, fine projections might be generated on the surface or unevenness is caused in the thickness, which lowers surface profile. In order to reduce the amount of oligomer component, it is only necessary to optimize selection of polymerization catalyst or hydrogenation catalyst, reaction conditions of polymerization, hydrogenation and the like, temperature conditions in a pelletization process of the resin as a molding material and the like. The amount of oligomer component can be measured by GPC using cyclohexane (or toluene if the resin material is not dissolved).

The thickness of the transparent substrate used in the present invention is not particularly limited but from the viewpoints of material costs, thinning and weight reduction, the thickness is usually 1 to 1000 μm, preferably 5 to 300 μm, or more preferably 30 to 100 μm.

The transparent substrate used in the present invention is preferably surface-treated in advance. By applying the surface treatment, close contact between the transparent substrate and the oriented film can be improved. The surface treatment means include glow discharge treatment, corona discharge treatment, ultraviolet (uv) treatment, flame treatment and the like. To provide an adhesive layer (undercoating layer) on the transparent substrate is also preferable in improving close contact between the transparent substrate and the oriented film.

### [Oriented Film of Optical Element]

An oriented film is formed on the surface of the transparent substrate for orientation-regulation of the resin layer having cholesteric regularity in one direction in a plane. The oriented film contains polymer such as polyimide, polyvinyl alcohol, polyester, polyarylate, polyamideimide, and polyetherimide. An oriented film can be obtained by applying a solution containing the polymer (a composition for oriented film) in a film state, drying it, and rubbing it in one direction.

Methods of applying in a film state include spin-coating method, roll-coating method, flow-coating method, printing method, dip-coating method, casting method, bar-coating method, die-coating method, gravure printing method and the like.

The methods of rubbing are not particularly limited but include a method of rubbing the oriented film with a roll around which a cloth made of synthetic fiber such as nylon or natural fiber such as cotton or felt is wound in a given direction. In order to remove fine powders (foreign substances) generated at rubbing and to clean the surface of the oriented film, it is preferable that the formed oriented film is cleaned by isopropyl alcohol or the like.

Other than the method of rubbing, a method of irradiating polarized ultraviolet ray to the surface of the oriented film can also impart a function of orientation-regulation of the resin layer with cholesteric regularity in the oriented film in one direction in a plane.

The thickness of the oriented film is preferably 0.01 to 5 μm, or more preferably 0.05 to 1 μm.

### [Cholesteric Resin Layer]

The circular polarizing reflector comprises a resin layer having cholesteric regularity. The cholesteric regularity is a structure that an angle of molecular axes are sequentially displaced (twisted) in line with the normal direction of a plane such that the molecular axes are aligned in a given direction on one plane but the direction of the molecular axes is slightly displaced with an angle on the subsequent plane and the angle is further displaced on the further subsequent plane. Such a structure that the direction of the molecular axes is twisted is called as a chiral structure. The normal line of the plane (chiral axis) is preferably substantially in parallel with the thickness direction of the cholesteric resin layer. The thickness of the cholesteric resin layer is preferably 1 μm to 10 μm, or more preferably 1 μm to 5 μm.

### <Material to Form Cholesteric Resin Layer (1): Liquid Crystal Polymer>

Materials for forming the cholesteric resin layer first include a liquid crystal polymer.

Substances are in any of three states (phase) of gas, liquid or solid according to conditions such as a temperature and pressure in general. The liquid crystal is described as “in a state in the middle of liquid and solid.” In general, a liquid crystal substance is solid at a low temperature and transparent liquid at a high temperature as with the other substances, but it becomes a cloudy liquid state in a temperature range in between. This state is a liquid crystal state. The liquid crystal substance showing this state has an elongated rod-like or disc-like portion in its molecular structure. In the liquid crystal state, this portion is in a state to become “state to be solid”, that is, to be aligned regularly, while the other portion is in a “state to be liquid”, that is, in a state where a free position can be maintained in a fluid manner. The molecule in the liquid crystal changes its optical characteristics when the portion in the “state to be solid” is aligned regularly according to ambient conditions such as an electric field and temperature, its aligned state is changed or further reduced to pieces. The liquid crystal substance is in a liquid state and fluid in the liquid crystal state but since the molecules are aligned with regularity, it shows the same nature as that of a crystal. That is, it is in a “liquid state but having a nature of a crystal”. The liquid crystal polymer is a polymer having such liquid crystal nature. By laminating this liquid crystal polymer on the oriented film in a film state, a cholesteric resin layer can be obtained.

Such liquid crystal polymers include a polymer having a mesogenic structure. Mesogen is a conjugated linear atomic group imparting liquid-crystal orientation.

Polymers having the mesogenic structure include those having a structure in which a mesogenic group made up by para-substituted cyclic compounds and the like is bonded to the polymer main chain such as polyester, polyamide, polycarbonate, polyesterimide and the like directly or through a spacer portion imparting bending property; and those having a structure in which a low-molecular crystallized compound (mesogen portion) made up by para-substituted cyclic compounds and the like is bonded to the polymer main chain such as polyacrylate, polymethacrylate, polysiloxane, polymalonate and the like directly or through the spacer portion made by conjugated atomic group.

The spacer portions include a polymethylene chain, polyoxymethylene chain and the like. The carbon number contained in a structural unit forming the spacer portion is determined as appropriate by a chemical structure and the like of the mesogen portion, and in the case of polymethylene chain, the number of carbon atoms is generally 1 to 20, or preferably 2 to 12, and in the case of polyoxymethylene chain, the number of carbon atoms is 1 to 10, or preferably 1 to 3.

Other examples of the liquid crystal polymer include nematic liquid crystal polymer containing low-molecular chiral agent; liquid crystal polymer to which chiral component is introduced; a mixture of nematic liquid crystal polymer and cholesteric liquid crystal polymer and the like. The liquid crystal polymer to which chiral component is introduced is a liquid crystal polymer that performs the function of chiral agent. With the mixture of nematic liquid crystal polymer and cholesteric liquid crystal polymer, a pitch of the chiral structure of the nematic liquid crystal polymer can be adjusted by varying the mixing ratio.

There can be also those imparted with cholesteric regularity by a method of introducing an appropriate chiral component or low-molecular chiral agent or the like made of a compound having asymmetric carbon into those having a para-substituted cyclic compound imparting nematic orientation made of para-substituted aromatic unit or para-substituted cyclohexyl unit or the like such as azomethine, azo, azoxy, ester, biphenyl, phenylcyclohexane and bicyclohexane (See Japanese Patent Laid-Open No. 55-21479, U.S. Pat. No. 5,332,522 and the like). Terminal substituents on the para-position in a para-substituted cyclic compound include cyano group, alkyl group, alkoxyl group and the like.

The liquid crystal polymer is not limited by its manufacture. The liquid crystal polymer can be obtained by radical polymerization, cationic polymerization or anionic polymerization of a monomer having a mesogenic structure, for example. The monomer having a mesogenic structure can be obtained by introducing a mesogenic group into a vinyl monomer such as acrylic ester and methacrylic ester directly or through a spacer portion by a known method. The liquid crystal polymer can be also obtained by addition reaction of vinyl-substituted mesogenic monomer in presence of platinum catalyst through Si—H bonding of plyoxymethylsilylene; by introducing a mesogenic group by esterification reaction using phase transfer catalyst through a functional group imparted to the main chain polymer; and by polycondensation reaction between monomer in which a mesogenic group is introduced in a part of malonic acid through a spacer portion as necessary and diol.

### (Chiral Agent to be Introduced or Contained in Liquid Crystal Polymer)

As a chiral agent to be introduced or contained in the liquid crystal polymer, those known in the related art can be used. The chiral monomer described in Japanese Patent Laid-Open No. 6-281814, the chiral agent described in Japanese Patent Laid-Open No. 8-209127, a photoreactive chiral compound described in Japanese Patent Laid-Open No. 2003-131187 and the like can be cited.

As the chiral agent, in order to avoid unintended change in a phase transition temperature caused by addition of the chiral agent, the chiral agent itself preferably shows liquid crystallinity. Moreover, from the viewpoint of economy, HTP (=1/P·c), which is an index indicating an efficiency to twist the liquid crystal polymer, is preferably larger. Here, P represents a pitch length of the chiral structure and c for a concentration of the chiral agent. The pitch length of the chiral structure is a distance in the chiral axial direction from when a direction of the molecular axis in the chiral structure is displaced by a small angle as it progresses on a plane and till it returns to the original molecular axial direction.

### <Material to Form Cholesteric Resin Layer (2): Polymerizable Composition>

As a suitable material for forming the cholesteric resin layer, a polymerizable composition comprising a polymerizable liquid crystal compound, preferably a polymerizable composition comprising a polymerizable liquid crystal compound, a polymerization initiator, and a chiral agent are mentioned. Examples of a method of forming the cholesteric resin layer using this material include a method of dissolving a polymerizable liquid crystal compound, a polymerization initiator, and a chiral agent and a surfactant, an orientation adjuster and the like as necessary to obtain an application liquid, applying this on the substrate in a film state, drying it and polymerizing the dried film.

### Polymerizable Liquid Crystal Compound to be Comprised in Polymerizable Composition)

As the polymerizable liquid crystal compound, rod-like liquid crystal compounds are preferably used.

The rod-like liquid compounds include a compound represented by the following formula (1):

R1-B1-A1-B3-M-B4-A2-B2-R2 Formula (1)

In the formula (1), A1 and A2 are spacer groups as will be described later, but B1 and B3 or B4 and B2 may be bonded directly by omitting the spacer group.

R1 and R2 in the formula (1) represent polymerizable groups. Specific examples of R1 and R2, which are polymerizable groups, include (r-1) to (r-15) shown in the chemical formula 1, but not limited by them.

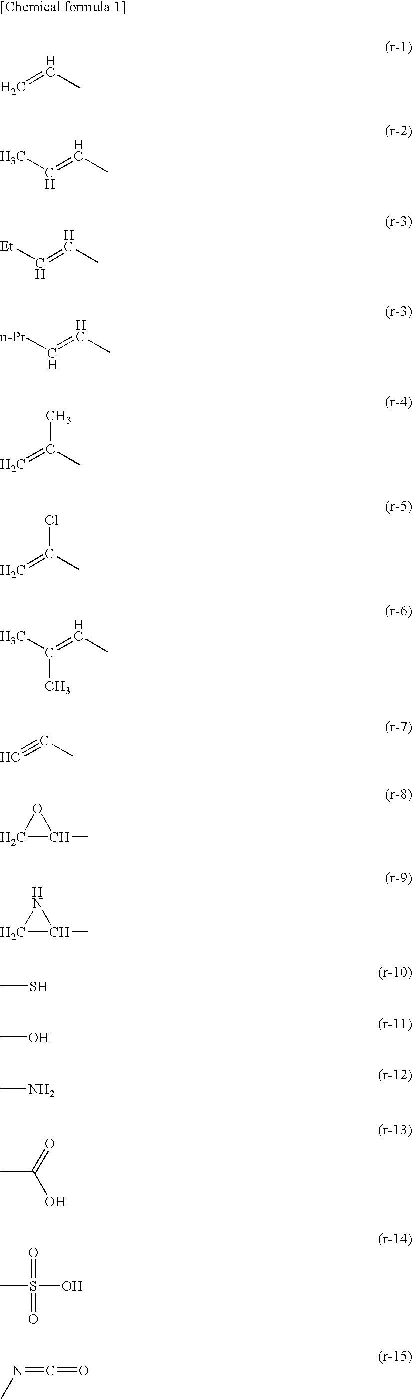

B1, B2, B3, and B4 represent single bonds or divalent bonded groups independently. At least one of B3 and B4 is preferably —O—CO—O—.

A1 and A2 represent spacer groups with carbon number of 1 to 20. The spacer groups include polymethylene group, polyoxymethylene group and the like. The number of carbon contained in a structural unit forming the spacer group is determined as appropriate by a chemical structure or the like of the mesogenic group. In general, in the case of the polymethylene group, the carbon number is 1 to 20, or preferably 2 to 12, while in the case of the polyoxymethylene group, the carbon number is 1 to 10, or preferably 1 La 3.

M represents a mesogenic group. A material forming the mesogenic group is not particularly limited, but azomethines, azoxys, cyanobiphenyls, cyanophenylesters, benzoate esters cyclohexanecarboxylic acid phenylesters, cyanophenylcyclohexanes, cyano substituted phenylpyrimidines, alkoxy substituted phenylpyrimidines, phenyldioxanes, tolans, and alkenylcyclohexylbenzonitriles are preferably used.

### (Polymerization Initiator to be Comprised in Polymerizable Composition)

The polymerization initiator includes a thermal polymerization initiator and an optical polymerization initiator, but the optical polymerization initiator is preferable since its polymerization reaction is faster.

The optical polymerization initiators include multinuclear quinone compounds (U.S. Pat. Nos. 3,046,127, 2,951,758), oxadiazole compounds (U.S. Pat. No. 4,212,970), α-carbonyl compounds (U.S. Pat. Nos. 2,367,661, 2,367,670), acyloin ethers (U.S. Pat. No. 2,448,828), α-hydrocarbon substituted aromatic acyloin compounds (U.S. Pat. No. 2,722,512), combination of triarylimidazoledimer and p-amino phenylketone (U.S. Pat. No. 3,549,367), acridine and phenazine compounds (Japanese Patent Laid-Open No. 60-105667, U.S. Pat. No. 4,239,850) and the like.

The amount of the polymerization initiator is preferably 1 to 10 parts by weight, more preferably 1 to 5 parts by weight to 100 parts by weight of the polymerizable liquid crystal compound. When the optical polymerizable initiator is used, ultraviolet is preferably used as irradiated light. The irradiation energy is preferably 0.1 mJ/cm² to 50 J/cm², or more preferably 0.1 mJ/cm² to 800 mJ/cm².

The irradiating method of ultraviolet is not particularly limited. The ultraviolet irradiation amount till polymerization conversion rate reaches 100% is selected according to type of the polymerizable liquid crystal compound as appropriate.

### (Chiral Agent to be Comprised in Polymerizable Composition)

As the chiral agent to be comprised in the polymerizable composition, those described in Japanese Patent Laid-Open No. 2003-66214, Japanese Patent Laid-Open No. 2003-313187, U.S. Pat. No. 6,468,444, WO98/00428 and the like can be used as appropriate, but those with large HTP, which is an index indicating efficiency to twist the liquid crystal compound is preferable from the viewpoint of economy. HTP is represented by the formula: HTP=1/P·c. P represents a pitch length of the chiral structure and c for a concentration of the chiral agent. In order to avoid unintended change in a phase transition temperature caused by addition of the chiral agent, the chiral agent itself preferably shows liquid crystallinity.

### (Other Compounding Agents to be Comprised in Polymerizable Composition)

In order to adjust surface tension of the application liquid and a film of the application liquid before polymerization, a surfactant can be used. Nonionic surfactant is particularly preferable, and an oligomer with a molecular weight of several thousands is preferable. Such surfactants include KH-40 made by AGC SeimiChemical Co., Ltd.

The orientation adjuster is to control an orientation state on the surface of the cholesteric resin layer on the air side formed on the substrate and also functions as the surfactant in some cases, but resins are used as appropriate depending on the intended orientation state. Those resins include polyvinylalcohol, polyvinylbutyral or their modified substances but not limited to them.

As a solvent used for preparing the application liquid, organic solvents are preferably used. Examples of the organic solvent include ketones, alkylhalides, amides, sulfoxido, heterocyclic compounds, hydrocarbons, esters, and ethers. When a load to the environment is particularly considered, ketones are preferable. Two or more of organic solvents may be used at the same time.

In order to apply the application liquid in a film state, known methods such as extrusion coating, direct gravure coating, reverse gravure coating and diecoating can be executed.

The cholesteric resin layer used in the present invention is preferably non-liquid crystalline resin layer, since in the non-liquid crystalline substances, cholesteric regularity is not changed by an ambient temperature or electric field. The non-liquid crystalline cholesteric resin layer can be obtained by selecting those comprising a polymerizable liquid crystal compound having two or more polymerizable groups as the polymerizable composition and by polymerizing them. By the polymerizable liquid crystal compound having two or more polymerizable groups, a relatively rigid bridging structure is introduced into a cholesteric resin and a resin which does not cause liquid crystallinity can be obtained.

When light enters the resin layer having cholesteric regularity, only circular polarized light, which is either of clockwise or counterclockwise in a specific wavelength region, is reflected. Light other than the reflected circular polarized light is transmitted. This specific wavelength region by which the circular polarized light is reflected is called as the selective reflection band.

As shown in FIG. 3, white light incident to the cholesteric resin layer of the circular polarizing reflector at an incident angle of θ₁ is refracted on the surface of the cholesteric resin layer and passes through the cholesteric resin layer at an incident angle of θ₂, and one of the circular polarized light is reflected at a reflective angle of θ₂ in the cholesteric resin layer having the pitch length P corresponding to the wavelength λ (layer noted as P2 in FIG. 3), refracted on the surface of the cholesteric resin layer and exits at an outgoing angle of θ₁. The refraction is performed according to Snell's law.

A helical axis 4 representing a rotating axis when the molecular axis is twisted in the chiral structure is parallel with the normal line of the cholesteric resin layer, the pitch length F of the chiral structure and the wavelength λ of the reflected circular polarized light have a relation in a formula (2) and a formula (3):

λ_{c}=n×P×cos θ₂ Formula (2)

nₒ×P×cos θ₂≦λ≦nₑ×P×cos θ₂ Formula (3)

In the formulas, nₒ represents a refractive index in the short-axis direction of the rod-like liquid crystal compound, nₑ represents the refractive index in the long-axis direction of the rod-like liquid crystal compound, and n=(nₑ nₒ)/2, P represents the pitch length of the chiral structure.

That is, the center wavelength λ_{c} of the selective reflection band depends on the pitch length P of the chiral structure in the cholesteric resin layer. By varying the pitch length of the chiral structure, the selective wavelength band can be changed. Also, the reflectivity is in proportion La the number of laminations in the chiral structure. In order to adjust the reflectivity, the number of layers in the chiral structure, that is, the thickness is adjusted. Since the width of the selective reflection band depends on a difference between nₒ and nₑ, a liquid crystal compound which is easy to be manufactured and appropriate should be selected.

By laminating the optical element of the present invention on a linear polarizer, a polarizing plate can be obtained. Also, a retardation plate can be obtained by laminating the optical element of the present invention on a retardation element. By laminating the linear polarizer or retardation element, an air layer between the elements is eliminated and unwanted reflection or interference on the interface can be reduced. By using the linear polarizer or retardation element instead of the transparent substrate on which the cholesteric resin layer is laminated, the cholesteric resin layer can be laminated directly on the linear polarizer or retardation element.

Also, by combining the optical element of the present invention with another optical element, an illuminating device, a polarization illuminating device and a liquid crystal display can be obtained.

The linear polarizer transmits one of two linear polarizers crossing at a right angle. For example, those obtained by having a dichroic substance such as iodine and dichroic dye adsorbed in a hydrophilic polymer film such as polyvinyl alcohol film, ethylene-vinyl acetate partially saponified film and the like and uniaxially stretching it, those obtained by uniaxially stretching the above hydrophilic polymer film and having dichroic material adsorbed, a polyene-oriented film such as dehydrated substance of polyvinyl alcohol, dehydrochlorinated substance of polyvinyl chloride and the like are cited. In addition, polarizers having a function of separating polarized light into a reflected light and transmitted light such as a grid polarizer and a multilayer polarizer can be cited. Among them, polarizers comprising polyvinyl alcohol are preferable.

The polarization degree of the linear polarizer used in the present invention is not particularly limited but it is preferably 98% or more, more preferably 99% or more. The average thickness of the linear polarizer is preferably 5 μm to 80 μm.

A pair of linear polarizers (hereinafter the pair of linear polarizers are referred to as a linear polarizer X and a linear polarizer Y (analyzer) separately, in some cases) are arranged with a liquid crystal cell between them so that the polarizing transmission axes are parallel with or perpendicular to each other. The linear polarizer might have its polarizing performance changed by absorption of moisture. In order to prevent that, a protective film is usually bonded to both faces of the linear polarizer X or the analyzer. The protective film to be bonded on the analyzer may be provided with an antireflection layer, an antifouling layer, an antiglare layer or the like.

The retardation element is an element which can change a phase of light. It includes the one obtained by stretching a polymer film and orienting it, for example. The retardation element can be used as the protective film to be bonded on the linear polarizer.

The illuminating device of the present invention has a light reflective element, a light source, a light diffusing element, and an optical element of the present invention arranged in this order. Also, the polarization illuminating device of the present invention has the light reflective element, the light source, the light diffusing element, and a polarizing plate of the present invention arranged in this order. In the polarizing plate, the optical element of the present invention is preferably arranged on the light diffusing element side rather than the linear polarizer. In addition, a prism sheet, a reflective polarizer, a ¼ wavelength plate, a ½ wavelength plate, a viewing angle compensating film, an antireflection film, an antiglare film or the like may be arranged.

The light reflective element is an element that can reflect light. Specifically, it includes a reflector provided with a reflective metal film or white film. The light source used in the present invention may be any type as long as it emits white light, and it can be selected from a cold cathode tube, a hot cathode tube, a light emitting diode, and an electroluminescence. The light diffusing element is an element to diffuse light to make it diffused light in order to eliminate in-plane distribution of brightness. Specifically, those in which a light diffusing material such as a silicone bead is distributed in a transparent substrate (also called as a light diffusing plate), those in which a light diffusing material is applied on the surface of a transparent substrate (also called as a light diffusing sheet) and the like.

The liquid crystal display of the present invention is provided with the optical element of the present invention. Moreover, it is provided with the polarizing plate, the retardation plate, and the illuminating device or the polarization illuminating device. Particularly, the light source, the optical element of the present invention, the linear polarizer X, the liquid crystal cell, and the linear polarizer Y are preferably arranged in this order. In addition, a reflective element, alight guide plate, a light diffusing element, a prism sheet, a reflective polarizer, a ¼ wavelength plate, a ½ wavelength plate, a viewing angle compensating film, an antireflection film, an antiglare film and the like may be arranged.

The liquid crystal cell has a liquid crystal substance filled between two glass substrates provided with transparent electrodes opposed to each other with a gap of several μm, in which a voltage is applied to the electrode to change the oriented state of the liquid crystal so as to control a light amount passing therethrough.

The liquid crystal cells are classified according to a method of changing the oriented state of the liquid crystal substance (operation mode) such as TN (Twisted Nematic) liquid crystal cell, STN (Super Twisted Nematic) liquid crystal cell, HAN (Hybrid Alignment Nematic) liquid crystal cell, IPS (In Plane Switching) liquid crystal cell, VA (Vertical Alignment) liquid crystal cell, MVA (Multi-domain Vertical Alignment) liquid crystal cell, OCB (Optical Compensated Bend) liquid crystal and the like.

FIG. 4 is a diagram illustrating configuration of an example of the liquid crystal display of the present invention. As shown in FIG. 4, a reflector 20, a cold cathode tube 19, a light diffusing plate 18, a circular polarizing reflector 17, a linear polarizer X, a liquid crystal cell 12, and a linear polarizer Y are arranged in this order. When light from the light source enters the circular polarizing reflector at an incident angle of 0 degrees, since the selective reflection band of the optical element is near the infrared region, each light of blue, green and red is transmitted as it is. If the incident angle is larger, the selective reflection band is shifted to the short-wavelength side, and red light is partially reflected and the light transmittance of the red light is lowered.

And at the incident angle of 60 degrees, the average transmittance of light with the wavelength 600 nm to 700 nm is adjusted to 40% or more and 80% or less. Also, the average reflectivity of light with the wavelength 600 nm to 700 nm is adjusted.

By this operation, balance of red light to blue light and green light is adjusted, and an image with good color balance both in the front and diagonal observations can be displayed.

### EXAMPLES

Examples and comparative examples are shown below and the present invention will be described more specifically, but the present invention is not limited to the following examples. Parts and % are weight standard unless described otherwise.

### Example 1

An optically isotropic film with a thickness of 100 μm (product name: “ZEONOR Film ZF14” by Zeon Corporation) made of a norbornene polymer was used as a transparent substrate. The both faces of the transparent substrate were plasma-treated so that wettability index became 56 dyne/cm. A composition for oriented film composed of 5 parts of polyvinyl alcohol and 95 parts of water was applied on one face of the transparent substrate and dried to form a film. Then, rubbing was performed with a felt roll in a direction in parallel with the longitudinal direction of the transparent substrate so as to obtain an oriented film with an average thickness of 0.1 μm.

100 parts of nematic liquid crystal compound (product name: “LC242” by Badische Anilin und Soda Fabrik), 3.60 parts of chiral agent (product name: “LC756” by Badische Anilin und Soda Fabrik), 3.21 parts of optical polymerization initiator (product name: “Irgacure907” by Ciba Specialty Chemicals Inc.) and 0.11 part of surfactant (product name: “KH-40” by AGC SeimiChemical Co., Ltd.) were dissolved in 160 parts of methylethylketone and filtered using a CD/X syringe filter made of polyfluoroethylene with a hole diameter of 2 μm so as to prepare a liquid crystal coating.

On the oriented film, the liquid crystal coating was applied with a dried thickness of 1.85 μm and dried at 100° C. for 5 minutes. Then, ultraviolet ray was irradiated at 150 mJ/cm² so as to form a cholesteric resin layer and to have a circular polarizing reflector.

To this circular polarizing reflector, a paralleled white light having a light emitting spectrum shown in FIG. 1 was made to enter at an incident angle of 0 degrees and light transmittance was measured by a spectroscope (product name: “S-2600” by SoumaOpt Co., Ltd.). The selective reflection band at the incident angle of 0 degrees was at the wavelength 700 nm to 820 nm, and the average transmittance of light with the wavelength of 600 nm to 700 nm at the incident angle of 0 degrees was 89%.

Then, the paralleled white light (light with the wavelength λ_{R1} indicating the maximum emission intensity in the wavelength band of 600 nm to 700 nm being 630 nm) was made to enter at the incident angle of 60 degrees and the light transmittance was similarly measured. The average transmittance of the light with the wavelength of 600 nm to 700 nm at the incident angle of 60 degrees was 71%. These and the other physical characteristics are shown in Table 1.

The circular polarizing reflector was installed in a liquid crystal display with the configuration shown in FIG. 4 and chromaticity change depending on an observation angle was visually evaluated. Little chromaticity change was found in a range of right and left 0 to 80 degrees.

TABLE 1

| | | Comp. | | Comp. |
|---|---|---|---|---|
| | Ex. 1 | Ex. 1 | Ex. 2 | Ex. 2 |
| Pitch of cholesteric | 460 | None | 470 | 365 |
| layer [nm] | | | | |
| Reflection band at | 700-820 | None | 690-850 | 530-630 |
| incident angle | | | | |
| 0 degrees [nm] | | | | |
| Maximum reflectivity | 26% | — | 24% | 28% |
| at incident angle | | | | |
| 0 degrees | | | | |
| Wavelength | 730 | — | 760 | 555 |
| indicating maximum | | | | |
| reflectivity at | | | | |
| incident angle | | | | |
| 0 degrees [nm] | | | | |
| Average | 89% | 90% | 88% | 87% |
| transmittance of | | | | |
| wavelength 600 nm to | | | | |
| 700 nm at incident | | | | |
| angle 0 degrees | | | | |
| Average | 71% | 82% | 71% | 82% |
| transmittance of | | | | |
| wavelength 600 nm to | | | | |
| 700 nm at incident | | | | |
| angle 60 degrees | | | | |
| Average reflectivity | 29% | 18% | 29% | 18% |
| of wavelength 600 nm | | | | |
| to 700 nm at | | | | |
| incident angle 60 | | | | |
| degrees | | | | |
| Average reflectivity | 19% | — | 20% | 12% |
| at incident angle 60 | | | | |
| degrees at wavelength | | | | |
| indicating maximum | | | | |
| reflectivity at | | | | |
| incident angle | | | | |
| 0 degrees | | | | |
| Reflectivity ratio | 19%/ | — | 20%/ | 12%/ |
| between incident | 26% = | | 24% = | 28% = |
| angle 0 degrees and | 73% | | 83% | 43% |
| incident angle | | | | |
| 60 degrees | | | | |

* Comparative Example 1: There is no selective reflection band and it can not be defined.
* A sum of the average transmittance and the average reflectivity of the wavelength 600 nm to 700 nm at the incident angle of 60 degrees is approximately 100%.

### Comparative Example 1

Using a film made of a norbornene polymer (product name: “ZEONOR Film ZF14” by Zeon Corporation, a thickness of 100 μm), the light transmittance was measured similarly to Example 1. The selective reflection band was not confirmed, and the average transmittance of the light with the wavelength of 600 nm to 700 nm when the paralleled white light was made to enter at the incident angle of 0 degrees was 90%. The average transmittance of the light with the wavelength of 600 nm to 700 nm when the paralleled white light was made to enter at the incident angle of 60 degrees was 82%. These and the other physical characteristics are shown in Table 1.

Instead of the circular polarizing reflector used in Example 1, the film made of the norbornene polymer was installed in the liquid crystal display with the configuration shown in FIG. 4 and the chromaticity change according to observation angle was visually evaluated. It was reddish at 60 degrees or more in the right and left direction.

### Example 2

An optically isotropic film with a thickness of 100 μm (product name: “ZEONOR Film ZF14” by Zeon Corporation) made of a norbornene polymer was used as a transparent substrate. The both faces of the transparent substrate were plasma-treated so that wettability index became 56 dyne/cm. A composition for oriented film composed of 5 parts of polyvinyl alcohol and 95 parts of water was applied on one face of the transparent substrate and dried to form a film. Then, rubbing was performed with a felt roll in a direction in parallel with the longitudinal direction of the transparent substrate so as to obtain an oriented film with an average thickness of 0.1 μm.

100 parts of nematic liquid crystal compound (product name: “LC242” by Badische Anilin und Soda Fabrik), 3.46 parts of chiral agent (product name: “LC756” by Badische Anilin und Soda Fabrik), 3.21 parts of optical polymerization initiator (product name: “Irgacure907” by Ciba Specialty Chemicals Inc.) and 0.11 part of surfactant (product name: “KH-40” by AGC SeimiChemical Co., Ltd.) were dissolved in 160 parts of methylethylketone and filtered using a CD/X syringe filter made of polyfluoroethylene with a hole diameter of 2 μm so as to prepare a liquid crystal coating.

On the oriented film, the liquid crystal coating was applied with a dried thickness of 1.88 μm and dried at 100° C. for 5 minutes. Then, ultraviolet ray was irradiated at 150 mJ/cm², so as to form a cholesteric resin layer and to obtain a circular polarizing reflector.

A section of the circular polarizing reflector was SEM-observed and a helical pitch of the cholesteric resin layer was 470 nm. These and the other physical characteristics are shown in Table 1.

To this circular polarizing reflector, a paralleled white light having a light emitting spectrum shown in FIG. 1 was made to enter at an incident angle of 0 degrees and light reflectivity was measured by a spectroscope (product name; “S-2600” by SoumaOpt Co., Ltd.). The selective reflection band was at the wavelength 690 nm to 850 nm, and the maximum reflectivity of 24% was shown at the wavelength of 760 nm.

Then, the paralleled white light was made to enter at the incident angle of 60 degrees and the light reflectivity was similarly measured. The reflectivity at the wavelength of 760 nm was 20%. And the reflectivity at the wavelength of 760 nm at the incident angle of 0 degrees was 83%. The average reflectivity of light with the wavelength of 600 nm to 700 nm at the incident angle of 60 degrees was 29%.

The circular polarizing reflector was installed in a liquid crystal with the configuration shown in FIG. 4 display and chromaticity change was visually evaluated. Little chromaticity change according to observation angle was found in a range of right and left 0 to 80 degrees.

### Comparative Example 2

An optically isotropic film with a thickness of 100 μm (product name: “ZEONOR Film ZF14” by Zeon Corporation) made of a norbornene polymer was used as a transparent substrate. The both faces of the transparent substrate were plasma-treated so that wettability index became 56 dyne/cm. A composition for oriented film composed of 5 parts of polyvinyl alcohol and 95 parts of water was applied on one face of the transparent substrate and dried to form a film. Then, rubbing was performed with a felt roll in a direction in parallel with the longitudinal direction of the transparent substrate so as to obtain an oriented film with an average thickness of 0.1 μm.

100 parts of nematic liquid crystal compound (product name: “LC242” by Badische Anilin und Soda Fabrik), 4.98 parts of chiral agent (product name: “LC756” by Badische Anilin und Soda Fabrik), 3.24 parts of optical polymerization initiator (product name: “Irgacure907” by Ciba Specialty Chemicals Inc.) and 0.12 part of surfactant (product name: “KH-40” by AGC SeimiChemical Co., Ltd.) were dissolved in 162 parts of methylethylketone and filtered using a CD/X syringe filter made of polyfluoroethylene with a hole diameter of 2 μm so as to prepare a liquid crystal coating.

On the oriented film, the liquid crystal coating was applied with a dried thickness of 1.50 μm and dried at 100° C. for 5 minutes. Then, ultraviolet ray was irradiated at 150 mJ/cm², so as to form a cholesteric resin layer and to obtain a circular polarizing reflector.

A section of the circular polarizing reflector was SEM-observed and a helical pitch of the cholesteric resin layer was 365 nm. These and the other physical characteristics are shown in Table 1.

Moreover, the light reflectivity was measured by the same manner as Example 2. The selective reflection band was at 530 nm to 630 nm and indicated the maximum reflectivity of 28% at the wavelength 555 nm. The reflectivity at the wavelength 555 nm when the paralleled white light was made to enter at the incident angle of 60 degrees was 12%, which was 43% of the reflectivity of the wavelength 555 nm at the incident angle of 0 degrees. The average reflectivity at the wavelength of 600 nm to 700 nm at the incident angle of 60 degrees was 18%.

Instead of the circular polarizing reflector used in Example 2, the circular polarizing reflector was installed in the liquid crystal display with the configuration shown in FIG. 4 and the chromaticity change according to observation angle was visually evaluated. Yellow green was presented at 60 degrees or more in the right and left direction.

1. An optical element used in a device having a light source, in which
a lower limit λ_{L} of a wavelength band reflecting light at an incident angle of 0 degrees is longer than a wavelength λ_{R1} of light indicating the maximum emission intensity in a wavelength band of 600 nm to 700 nm in the light emitted by the light source; and
average transmittance of the light with the wavelength 600 nm to 700 nm at the incident angle of 60 degrees is 40% or more and 80% or less.

2. The optical element according to claim 1, wherein the average transmittance of the light with the wavelength 600 nm to 700 nm at the incident angle of 0 degrees is 60% or more; and
the average transmittance of the light with the wavelength of 600 nm to 700 μm at the incident angle of 0 degrees is larger than the average transmittance of the light with the wavelength of 600 nm to 700 nm at the incident angle of 60 degrees.

3. The optical element according to claim 1, wherein the average transmittance of the light with the wavelength 600 nm to 700 nm at the incident angle of 60 degrees is 50% or more and 80% or less.

4. The optical element according to claim 1, comprising a resin layer having cholesteric regularity.

5. The optical element according to claim 1, which has a resin layer having cholesteric regularity, wherein chiral pitch of the resin layer is 400 nm or more; and the maximum reflectivity in a selective reflection band at the incident angle of 0 degrees is 10 or more and 40% or less.

6. The optical element according to claim 1, wherein the reflectivity when light with the wavelength indicating the maximum reflectivity in the selective reflection band at the incident angle of 0 degrees is incident at the incident angle of 60 degrees is 50% or more and 90% or less of the maximum reflectivity at the incident angle of 0 degrees.

7. The optical element according to claim 1, wherein the average reflectivity of light with the wavelength 600 nm to 700 nm at the incident angle of 60 degrees is 20% or more and 60% or less.

8. A polarizing plate in which the optical element according to claim 1 and a linear polarizer are laminated.

9. A retardation plate in which the optical element according to claim 1 and retardation element are laminated.

10. An illuminating device in which an optical reflective element, a light source, a light diffusing element and the optical element according to claim 1 are arranged in this order.

11. A polarization illuminating device in which an optical reflective element, a light source, a light diffusing element and the polarizing plate according to claim 8 are arranged in this order.

12. A liquid crystal display in which an optical reflective element, a light source, a light diffusing element, the optical element according to claim 1, a linear polarizer, a liquid crystal panel, and an analyzer are arranged in this order.

13. The liquid crystal display according to claim 12, wherein the light source is selected from a cold cathode tube, a hot cathode tube, a light emitting diode, and an electroluminescence.
